(19) United States
(12) Patent Application Publication
(10) Pub. No.: US 2024/0215481 A1
(43) Pub. Date: Jul. 4, 2024

(54) SELF-ADJUSTING ANTI-SCALP SYSTEM AND METHOD FOR WHEELED LAWN CARE MACHINE

(71) Applicant: Kubota Corporation, Osaka (JP)

(72) Inventors: Kirk Payne, Gainesville, GA (US); Bary Jordan, Gainesville, GA (US); Shoichiro Nagaishi, Gainesville, GA (US)

(21) Appl. No.: 18/147,889

(22) Filed: Dec. 29, 2022

(51) Int. Cl. A01D 34/74; A01D 34/64; A01D 34/81

(52) U.S. Cl. CPC A01D 34/74; A01D 34/64; A01D 34/81; A01D 2101/00

(57) ABSTRACT

An anti-scalp system is mounted to a lower deck of a riding mower and prevents the deck from contacting the ground. The system includes a first shaft, a second shaft, a resistance element, and a wheel. The first shaft is attached to the deck, and the second shaft slides within the first shaft between an extended position and a retracted position. The resistance element biases the second shaft toward the extended position. The wheel is rotatably coupled to a lower end of the second shaft. When the deck reaches a minimum height above the ground, the wheel contacts the ground, the second shaft slides upwardly within the first shaft to compress resistance element, and the compressed resistance element resists further upward movement of the second shaft to prevent the deck from contacting the ground. There may be a plurality of the anti-scalp systems mounted around the deck.

### FIELD

The present invention relates to deck suspension technologies for wheeled lawn care machines, and more particularly, embodiments concern an anti-scalp system and method for a wheeled lawn care machine, such as a riding mower, that automatically adjusts to varying terrain to prevent a lower deck from contacting the ground.

### BACKGROUND

Anti-scalp deck wheels are provided on some riding mowers to help prevent the deck from contacting the ground when passing over uneven ground, especially when the cutting height is set relatively short. Avoiding such contact prevents the blade from cutting off or “scalping” large clumps of grass. Generally, the bottom of an anti-scalp wheel should be manually adjusted to be approximately one inch or less above the ground, depending on the cutting height.

Current anti-scalp wheel technologies use multiple holes and rue rings with various collars to fix their positions relative to the cutting height. The current height adjustment process requires counting collars and/or hole locations and requires a significant amount of time and effort to set and, as necessary, adjust depending on the cutting height and terrain. As a result, many mower users do not pay attention to their anti-scalping wheels until the turf or terrain is damaged. Further, incorrect adjustment may result in the anti-scalp wheels being continuously in direct contact with the ground, which can lead to premature failure of mower components.

This background discussion is intended to provide information related to the present invention which is not necessarily prior art.

### SUMMARY

Embodiments address the above-described and other problems and limitations in the prior art by providing an anti-scalp system and method for a wheeled lawn care machine, such as a riding mower, that automatically adjusts to varying terrain to prevent a lower deck from contacting the ground. For example, embodiments of the anti-scalp system are self-adjusting, which advantageously avoids problems and limitations in the prior art in which an anti-scalp wheel may be adjusted too high, resulting in damage to turf and terrain, or too low, resulting in damage to other lawn care machine components.

In one embodiment, a wheeled lawn care machine is provided. The wheeled lawn care machine includes a drive apparatus, a lower deck, and an anti-scalp system. The drive apparatus is configured to propel the wheeled lawn care machine over the ground. The lower deck is powered by the drive apparatus and positioned above the ground. The anti-scalp system is mounted to the lower deck and prevents the lower deck from contacting the ground. The anti-scalp system includes (a) a first shaft attached to the lower deck, (b) a second shaft at least partly received within the first shaft and shiftable relative to the first shaft between an extended position and a retracted position, (c) a resistance element positioned within at least one of the first and second shafts and biasing the second shaft toward the extended position, and (d) a rollable element rotatably coupled with a lower end of the second shaft. When the lower deck reaches a minimum height above the ground, the rollable element contacts the ground, the second shaft slides within the first shaft toward the retracted position and compresses the resistance element, and the resistance element resists further upward movement of the second shaft so that the anti-scalp system prevents the lower deck from contacting the ground.

In another embodiment, a zero-turn riding lawn mower is provided. The zero-turn riding lawn mower includes a drive apparatus, a lower deck, and an anti-scalp system. The drive apparatus is for propelling the zero-turn riding lawn mower over the ground. The lower deck includes mowing blades that are powered by the drive apparatus and the lower deck is positioned above the ground. The anti-scalp system is mounted to the lower deck and prevents the lower deck from contacting the ground, the anti-scalp system includes (a) a first shaft attached to the lower deck, (b) a coil spring positioned within the first shaft, (c) a second shaft slidably received within the first shaft and including an upper end and a lower end, with the upper end being located proximate to the coil spring within the first shaft, and (d) a wheel rotatably coupled with the lower end of the second shaft. When the lower deck reaches a minimum height of between one and six inches above the ground, the wheel contacts the ground, the second shaft slides upwardly within the first shaft so that the upper end of the second shaft compresses the coil spring, and the coil spring resists further upward movement of the second shaft so that the anti-scalp system prevents the lower deck from contacting the ground.

In yet another embodiment, an anti-scalp method for a riding lawn mower is provided. The method includes the steps of: (a) contacting the ground with a rollable element of an anti-scalp system mounted on a lower deck of the riding lawn mower; (b) sliding a second shaft upwardly within a first shaft of the anti-scalp system to thereby compress a resistance element of the anti-scalp system, wherein said sliding is caused by an upward force from the contacting of step (a); and (c) resisting further upward movement of the second shaft by the resistance element so that the anti-scalp system prevents the lower deck from contacting the ground.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a plan view of an example wheeled lawn care machine in the form of a riding mower having a lower deck equipped with an anti-scalp system;

FIG. 2 is a cross-sectional elevation view of an embodiment of an anti-scalp system which may be mounted to the example wheeled lawn care machine shown in FIG. 1, wherein the anti-scalp system is shown not in contact with the ground;

FIG. 3 is a cross-sectional elevation view of the anti-scalp system of FIG. 2, wherein the anti-scalp system is shown in contact with the ground;

FIG. 4 is a cross-sectional elevation view of an implementation of the anti-scalp system of FIG. 2 using a roller rather than a wheel;

FIG. 5 is a cross-sectional elevation view of an implementation of the anti-scalp system of FIG. 2 using a ball rather than a wheel; and

FIG. 6 is a flowchart of steps involved in an anti-scalp method which may be employed with the example wheeled lawn care machine shown in FIG. 1.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly, embodiments provide an anti-scalp system and method for a wheeled lawn care machine, such as a riding mower, that automatically adjusts to varying terrain to prevent a lower deck from contacting the ground. Embodiments of the anti-scalp system are self-adjusting, which advantageously avoids problems and limitations in the prior art in which an anti-scalp wheel may be adjusting too high, resulting in damage to turf and terrain, or too low, resulting in damage to other lawn care machine components.

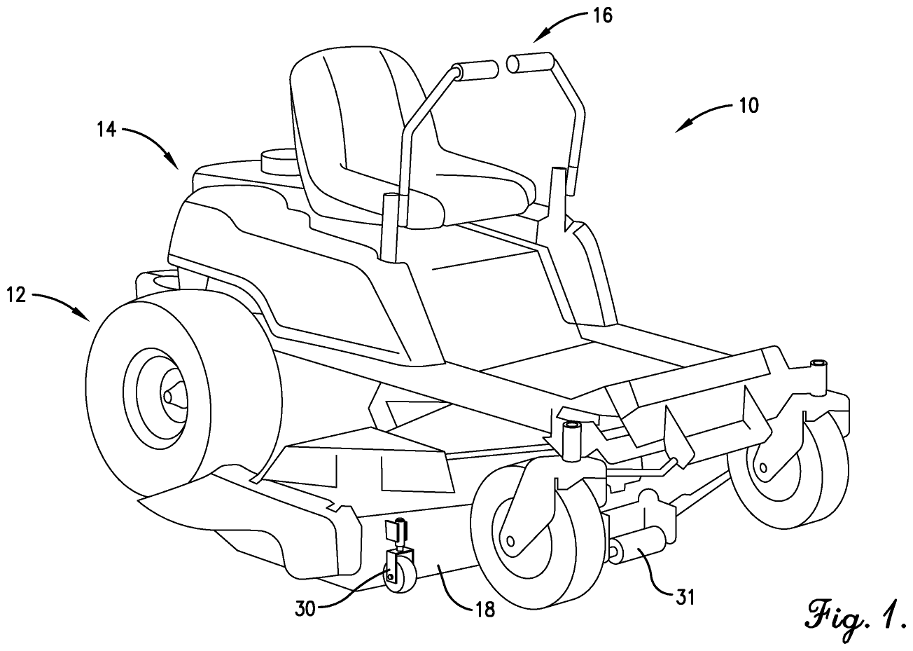

Referring to FIG. 1, an embodiment of an example wheeled lawn care machine 10 for performing tasks related to lawn care (e.g., cutting or mulching) may include a plurality of wheels 12, a drive apparatus 14, a control handle 16, a lower deck 18, and at least one anti-scalp system 30. The plurality of wheels 12 may be substantially any suitable number, design, and configured of wheels for accomplishing the task(s) of the lawn care machine 10. In various implementations, there may be three or four wheels, and the rear wheel(s) may be larger than the front wheel(s). The drive apparatus 14 may be a combustion engine or an electric motor suitable for propelling the lawn care machine 10 over the ground and for otherwise accomplishing the task(s) of the lawn care machine 10. In one implementation, the drive apparatus 14 may drive a cutting blade (not shown) of the lower deck 18. The control handle 16 may be configured to facilitate a user controlling a direction of travel of the lawn care machine 10. In various implementations, the control handle 16 may take the form of separate steering arms, as may be used in a riding lawn care machine, or a single joined handle, as may be used in a walk-behind lawn care machine. The lower deck 18 may be located lower than the drive apparatus 14 and may be configured to be normally positioned a particular distance, or within a particular range of distances, above generally flat ground during performance of the lawn care task(s). For example, the lower deck 18 may be positionable between one inch and six inches above the ground.

In one implementation of the first embodiment, the wheeled lawn care machine may be a riding lawn mower, such as a sit-down or stand-on zero-turn lawn mower, having two rear wheels, two front wheels, a combustion engine or electric motor driving a cutting blade, left and right steering control levers, and a lower deck partially surrounding the cutting blade and normally positioned between one and four inches above the ground. In an alternative implementation, the wheeled lawn care machine may be configured to be towed behind another vehicle, such as a lawn tractor. In this embodiment the towing vehicle may provide the control handle and the engine or motor, and power from the engine or motor may be delivered to the lawn care machine via a power takeoff connection to accomplish the lawn care task(s).

Referring again to FIG. 1, the anti-scalp system 30 may be configured to automatically adjust to varying terrain to prevent the lower deck 18 from contacting the ground, or to prevent the lower deck from falling below a minimum height of approximately between one and six inches above the ground, especially when travelling over uneven ground that is not generally flat.

Depending on the size and configuration of the lower deck, the lower deck may include one anti-scalp system or multiple anti-scalp systems. The anti-scalp system may be positioned on the lower deck in one or more of the following locations around the perimeter of the lower deck: front-middle, rear-middle, front-left, front-right, rear-left, and rear-right. FIG. 1 illustrates an embodiment where the lower deck 18 includes a front-right anti-scalp system 30, a front-left anti-scalp system (not shown), and a front-middle conventional anti-scalp wheel 31.

When only one anti-scalp system is used on the lower deck, the anti-scalp system may be positioned toward the front-middle of the lower deck. When only two anti-scalp systems are used on the lower deck, they may be positioned either at the front-left and front-right positions or at the front-middle and rear-middle positions. When three anti-scalp systems are used, two of them may be located at the left and right (front or rear) positions, and one may be located at a middle (front or rear) position. Additionally, as depicted in FIG. 1, the anti-scalp system 30 described herein can be used in combination with conventional anti-scalp wheels or rollers 31 on the lower deck 18.

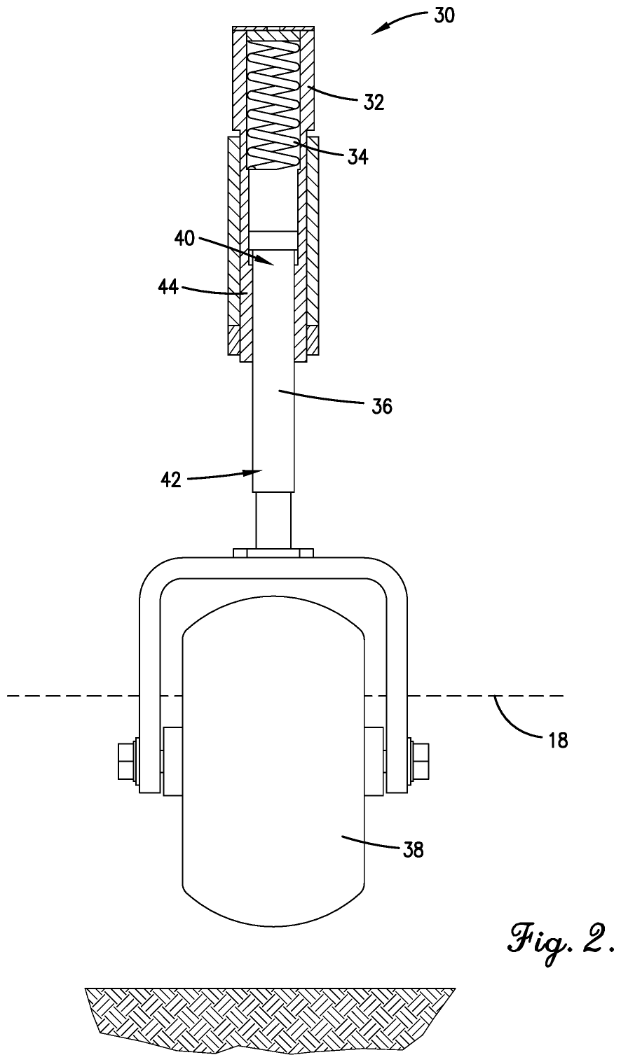

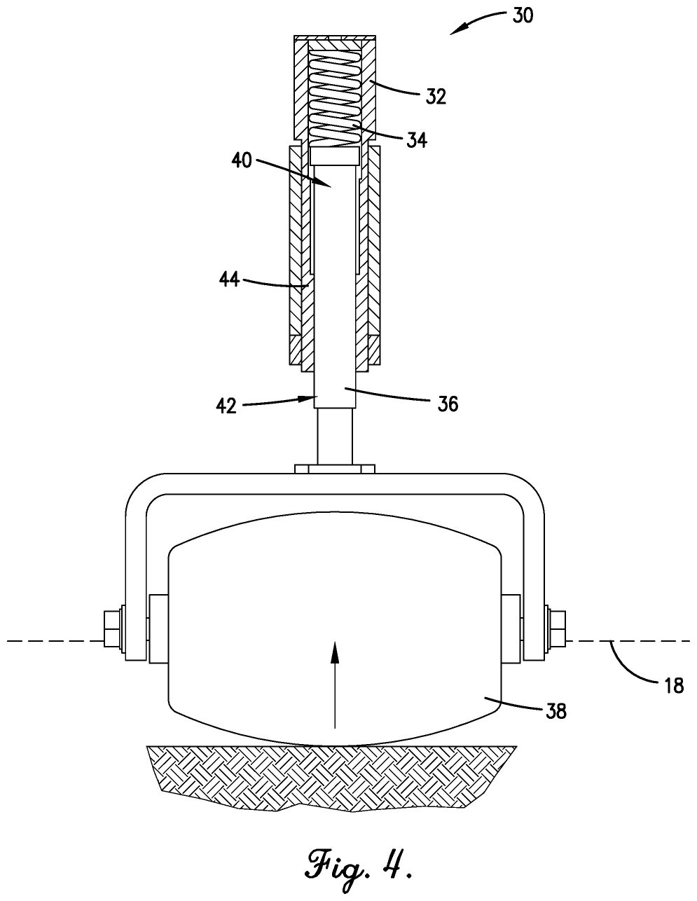

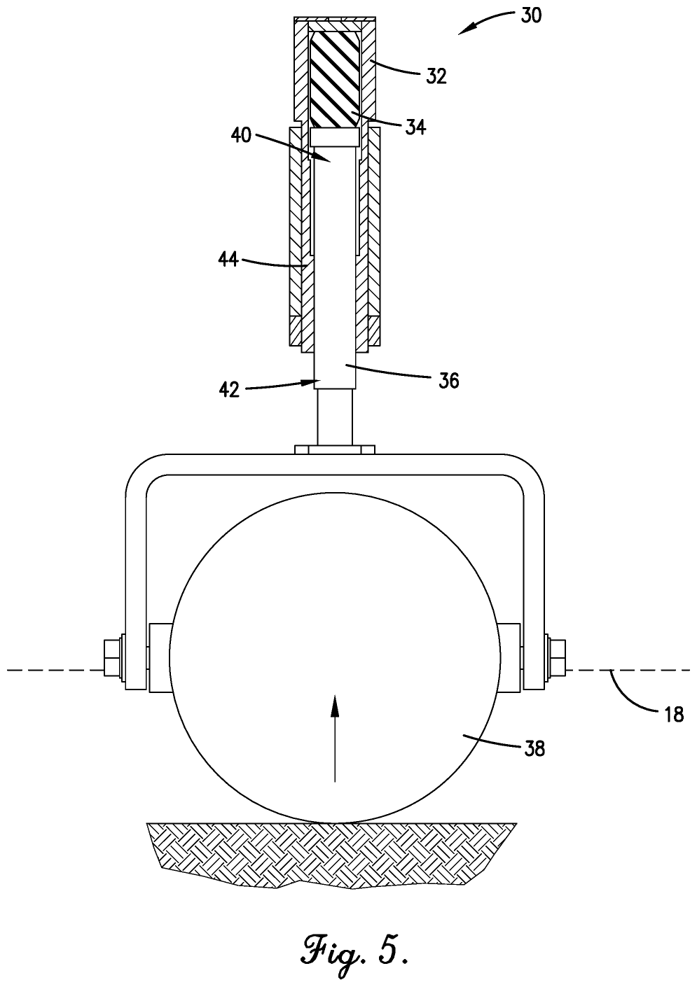

Referring particularly to FIGS. 2-5, an embodiment of the anti-scalp system 30 may comprise a first shaft 32, a resistance element 34, a second shaft 36, and a rollable element 38. The first shaft 32 may be suitably attached (e.g., by welding or bolting) to the lower deck 18 and provide an inner volume. In one implementation, the first shaft 32 may be generally cylindrical in shape, have an inner diameter, and be constructed of substantially any suitable material, such as aluminum or steel. The resistance element 34 may be positioned within the inner volume of the first shaft 32 and provide resistance to deformation when compressed. The resistance element 34 may incorporate or employ substantially any suitable design or technology, such as mechanical, hydraulic, and pneumatic, to accomplish its function. In one implementation, seen in FIGS. 2-4, the resistance element 34 may be a coil spring. In another implementation, seen in FIG. 5, the resistance element 34 may be a resilient material (e.g., foam rubber), structure (e.g., a honeycombed or other cell-divided volume), or compressible gas (e.g., air or nitrogen) that automatically returns to an original shape/volume after being compressed by movement of the second shaft 36 into the first shaft 32. The second shaft 36 may be slidably received within the first shaft 32 and include an upper end 40 located proximate to the resistance element 34 and a lower end 42. In one implementation, the second shaft 36 may be generally cylindrical in shape, have an outer diameter which is smaller than the inner diameter of the first shaft 32, and be constructed of substantially any suitable material such as aluminum or steel. In one implementation, there may be between three and six inches, or between four and five inches, of total travel between a maximum extension (i.e., extended position) and a minimum extension (i.e., retracted position) of the second shaft 36 relative to the first shaft 32. The resistance element 34, when compressed, biases the second shaft 36 toward the extended position. The rollable element 38 may be rotatably coupled with the lower end 42 of the second shaft 36. In various implementations, the rollable element 38 may be a solid wheel, an inflatable wheel, a roller (as seen in FIG. 4), or a ball (as seen in FIG. 5).

In one implementation, the anti-scalp system 30 may include one or more (e.g., upper and lower) mechanical stop structures 44 located on one or both of the first or second shafts 32,36 and configured to define a maximum and/or minimum extension or otherwise limit movement in one or both directions of the second shaft 36 relative to the first shaft 32. In one implementation, the resistance element 34 may be spaced apart (up to, e.g., one inch) from the upper end 40 of the second shaft 36 at a maximum extension (downward travel) of the second shaft 36 relative to the first shaft 32. In another implementation, the resistance element 34 may be connected to or otherwise remain in contact with the upper end 40 of the second shaft 36 at the maximum extension of the second shaft 36 relative to the first shaft 32.

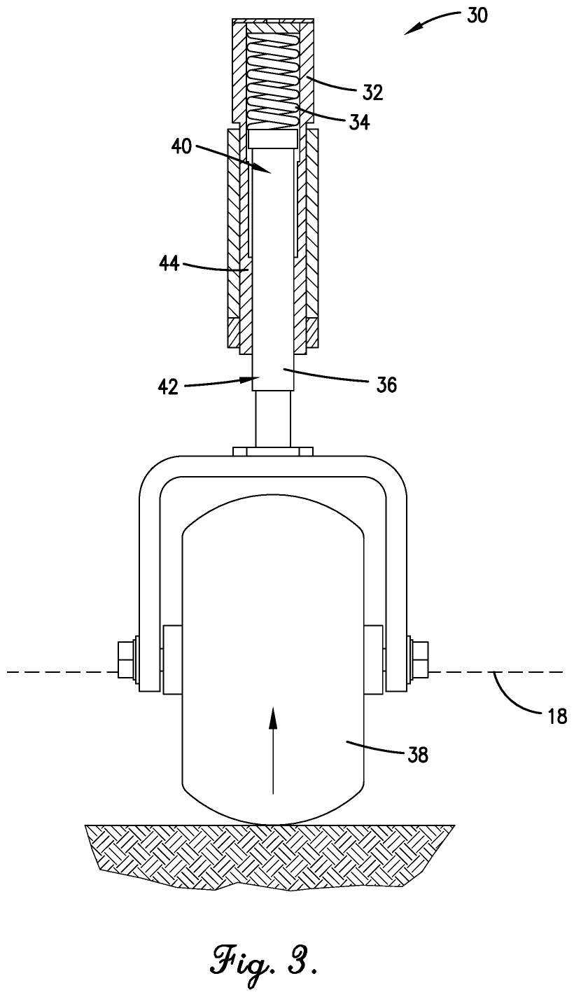

In operation, over generally flat ground, the rollable element 38 of the anti-scalp system 30 may be suspended in a “neutral” position at a particular height about the ground, as seen in FIG. 2. This may correspond to a maximum extension (downward travel) of the second shaft 36 relative to the first shaft 32. Over uneven ground that is not generally flat, when the lower deck 18 reaches the minimum height of approximately between one and six inches above the ground, the rollable element 38 may contact the ground, the second shaft 36 may slide upwardly within the first shaft 32 so that the upper end 40 of the second shaft 36 compresses the resistance element 34, as seen in FIG. 3, and the compressed resistance element 34 may resist further upward movement of the second shaft 36 which prevents further downward movement of the lower deck 18 and thereby prevents the lower deck 18 from contacting the ground.

Depending on the nature of the wheeled lawn care machine 10, there may be between one and ten of the anti-scalp systems 30 mounted to the lower deck 18 of the lawn care machine 10. For example, a riding mower may have four, five (e.g., one at each corner and one at the middle-rear), or between two and six of the anti-scalp systems 30 mounted at points around the lower deck 18.

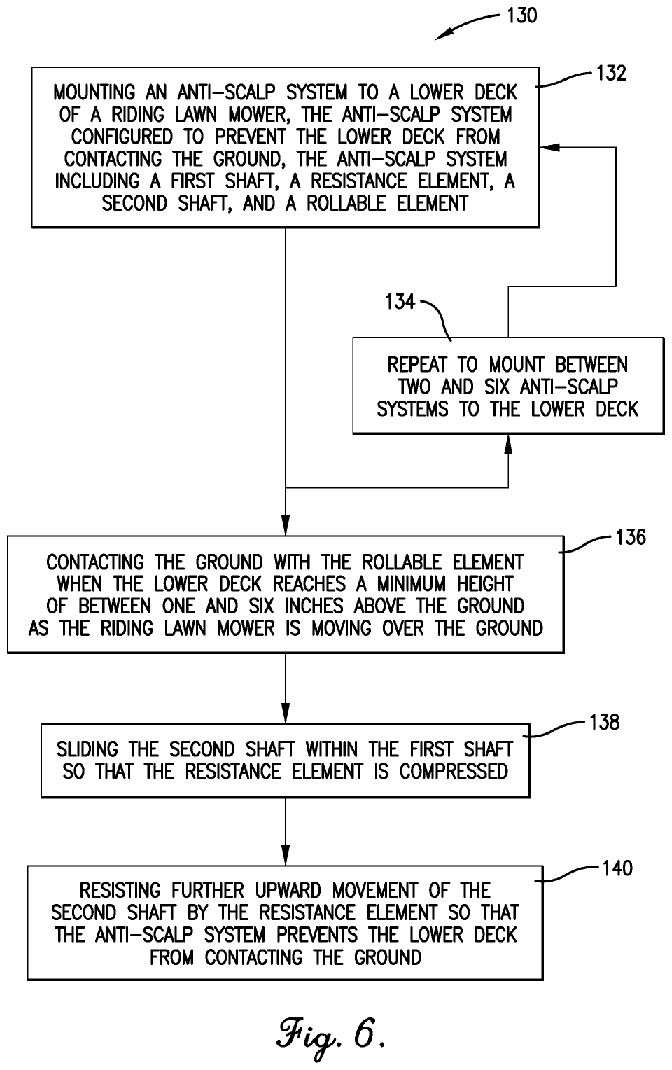

Referring also to FIG. 6, an embodiment of an anti-scalp method 130 may be employed with the example wheeled lawn care machine 10 described above. In one implementation, the method 130 may be implemented using the elements of the anti-scalp system 30 described above. Broadly, the method 130 may include the following steps.

An anti-scalp system may be mounted to a lower deck of the riding lawn mower, which may be a zero-turn riding lawn mower, wherein the anti-scalp system configured to prevent the lower deck from contacting the ground, as shown in 132. In one implementation, between two and six of the anti-scalp systems may be mounted to the lower deck, as shown in 134.

The ground may be contacted with the rollable element when the lower deck reaches a minimum height of between one and six inches above the ground as the riding lawn mower is moving over the ground, as shown in 136. The second shaft may be slid upwardly within the first shaft so that the upper end of the second shaft compresses the resistance element, as shown in 138. Further upward movement of the second shaft may be resisted by the resistance element so that the anti-scalp system prevents the lower deck from contacting the ground, as shown in 140. Implementations of the method 130 may include one or more of any additional features and functions associated with the example wheeled lawn care machine 10 and the anti-scalp system 30 described above.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A wheeled lawn care machine for moving over a ground, the wheeled lawn care machine comprising:
a drive apparatus for propelling the wheeled lawn care machine over the ground;
a lower deck powered by the drive apparatus and positioned above the ground; and
an anti-scalp system mounted to the lower deck and configured to prevent the lower deck from contacting the ground, the anti-scalp system including—
a first shaft attached to the lower deck,
a second shaft at least partly received within the first shaft and shiftable relative to the first shaft between an extended position and a retracted position,
a resistance element positioned within at least one of the first and second shafts and biasing the second shaft toward the extended position, and
a rollable element rotatably coupled with a lower end of the second shaft,
wherein when the lower deck reaches a minimum height above the ground, the rollable element contacts the ground, the second shaft slides within the first shaft toward the retracted position and compresses the resistance element, and the resistance element resists further upward movement of the second shaft so that the anti-scalp system prevents the lower deck from contacting the ground.

2. The wheeled lawn care machine of claim 1, wherein the wheeled lawn care machine is a riding lawn mower.

3. The wheeled lawn care machine of claim 2, wherein the riding lawn mower is a zero-turn riding lawn mower.

4. The wheeled lawn care machine of claim 1, wherein the rollable element is selected from the group consisting of wheels, rollers, and balls.

5. The wheeled lawn care machine of claim 1, wherein the resistance element is a coil spring.

6. The wheeled lawn care machine of claim 1, wherein the resistance element is a resilient material or structure that automatically returns to an original shape after being compressed by upward movement of the second shaft into the first shaft.

7. The wheeled lawn care machine of claim 1, wherein the resistance element is a compressible gas that automatically returns to an original volume after being compressed by upward movement of the second shaft into the first shaft.

8. The wheeled lawn care machine of claim 1, wherein the resistance element is spaced apart from an upper end of the second shaft at a maximum extension of the second shaft relative to the first shaft.

9. The wheeled lawn care machine of claim 1, wherein the resistance element remains in contact with an upper end of the second shaft at a maximum extension of the second shaft relative to the first shaft.

10. The wheeled lawn care machine of claim 1, the anti-scalp system further including a mechanical stop structure defining a maximum and/or minimum extension of the second shaft relative to the first shaft.

11. The wheeled lawn care machine of claim 1, further including between two and six of the anti-scalp systems mounted to the lower deck.

12. A zero-turn riding lawn mower for moving over a ground, the zero-turn riding lawn mower comprising:
a drive apparatus for propelling the zero-turn riding lawn mower over the ground;
a lower deck driven by the drive apparatus and positioned above the ground; and
an anti-scalp system mounted to the lower deck and preventing the lower deck from contacting the ground, the anti-scalp system including—
a first shaft attached to the lower deck,
a coil spring positioned within the first shaft,
a second shaft slidably received within the first shaft and including an upper end and a lower end, with the upper end being located proximate to the coil spring within the first shaft, and
a wheel rotatably coupled with the lower end of the second shaft,
wherein when the lower deck reaches a minimum height of between one and six inches above the ground, the wheel contacts the ground, the second shaft slides upwardly within the first shaft so that the upper end of the second shaft compresses the coil spring, and the coil spring resists further upward movement of the second shaft so that the anti-scalp system prevents the lower deck from contacting the ground.

13. The zero-turn riding lawn mower of claim 19, further including between two and six of the anti-scalp systems mounted to the lower deck.

14. An anti-scalp method for a riding lawn mower for moving over a ground, the anti-scalp method comprising:
(a) contacting the ground with a rollable element of an anti-scalp system mounted on a lower deck of the riding lawn mower;
(b) sliding a second shaft upwardly within a first shaft of the anti-scalp system to thereby compress a resistance element of the anti-scalp system, wherein said sliding is caused by an upward force from the contacting of step (a); and
(c) resisting further upward movement of the second shaft by the resistance element so that the anti-scalp system prevents the lower deck from contacting the ground.

15. The anti-scalp method of claim 14, wherein the riding lawn mower is a zero-turn riding lawn mower.

16. The anti-scalp method of claim 14, wherein the rollable element is selected from the group consisting of wheels, rollers, and balls.

17. The anti-scalp method of claim 14, wherein the resistance element is a coil spring.

18. The anti-scalp method of claim 14, wherein the resistance element is a resilient material, structure, or gas that automatically returns to an original shape or volume after being compressed by upward movement of the second shaft into the first shaft.

19. The anti-scalp method of claim 14, further comprising preventing further upward movement of the second shaft by a mechanical stop.

20. The anti-scalp method of claim 14, wherein between two and six of the anti-scalp systems are coupled to the lower deck.
